(19) United States
(12) Patent Application Publication
(10) Pub. No.: US 2025/0104543 A1
(43) Pub. Date: Mar. 27, 2025

(54) MOVEMENT TRACKING DEVICE PRODUCING AN AUDIBLE SOUND

(71) Applicant: Tamika Blanchard, Hinesville, GA (US)

(72) Inventor: Tamika Blanchard, Hinesville, GA (US)

(21) Appl. No.: 18/475,163

(22) Filed: Sep. 26, 2023

(51) Int. Cl. G08B 3/10; H01H 3/14

(52) U.S. Cl. CPC G08B 3/10; H01H 3/141; A43C 15/02

(57) ABSTRACT

A movement tracking device may comprise footwear and an adhesive substance, wherein a first side of the adhesive substance may be applied to a bottom side of the footwear, a second side of the adhesive substance is opposite the first side of the adhesive substance, the second side of the adhesive substance may make contact with a surface upon each step of the footwear, and the adhesive substance may emit an audible sound upon releasing contact with the surface. A movement tracking device may comprise footwear and an alarm mechanism, wherein the footwear comprises a sole, the alarm mechanism may be embedded inside the sole, and the alarm mechanism may emit an audible sound when a pressure is applied to the alarm mechanism.

### FIELD OF THE DISCLOSURE

The present disclosure relates generally to a movement tracking device producing an audible sound, and more particularly, to an audio mechanism which may be applied to footwear to alert others about movement and aid in locating an individual.

### BACKGROUND OF THE DISCLOSURE

Individuals who suffer from dementia often require consistent monitoring to ensure that the individual does not injure themselves. Even the early stages of dementia affect cognitive function and may create a state of confusion and disorientation. As such, individuals suffering dementia are especially likely to wander and become lost and/or trip and fall.

Traditionally, bells have often been adorned on individuals suffering from dementia to alert others of when they stand and walk around. However, bells are loud and very conspicuous and can cause feelings of humiliation and confusion in the individual. Furthermore, they might not be especially effective in alerting others of when the individual is walking, as the bells can ring with movements made by the individual while they are sitting or not moving.

Accordingly, there is need for a solution to at least one of the aforementioned problems. For instance, there is an established need for device that will alert others when an individual is moving around and aid in locating the individual without causing the individual embarrassment.

### SUMMARY OF THE DISCLOSURE

The present disclosure is directed to a movement tracking device producing an audible sound, and more particularly, to an audio mechanism which may be applied to the footwear to alert others of movement of an individual and aid in locating an individual. A movement tracking device may comprise a patch comprising an adhesive substance on a first side and a second side of the patch, wherein a first side of the adhesive substance may be applied to a bottom side of the footwear, a second side of the adhesive substance is opposite the first side of the adhesive substance, the second side of the adhesive substance may make contact with a surface upon each step of the footwear, and the adhesive substance may emit an audible sound upon releasing contact with the surface. A movement tracking device may comprise footwear and an alarm mechanism, wherein the footwear comprises a sole, the alarm mechanism may be embedded inside the sole, and the alarm mechanism may emit an audible sound when a pressure is applied to the alarm mechanism.

In a first implementation, an adhesive may be applied to a bottom side of the footwear to produce an audible sound when the footwear loses contact with a surface.

In a first aspect, the footwear may be any sort of footwear that can be worn by an individual.

In another aspect, the footwear may include a sole. The sole may have a top side and a bottom side opposite the top side. The sole's bottom side may be the bottom side of the footwear.

In another aspect, the adhesive may be any sort of adhesive substance such as glues, tapes, polymers, resins, epoxies, or the like and/or any combination thereof. The adhesive first side may be affixed to the bottom side of the footwear.

In another aspect, the patch may cover the entirety of the bottom side of the footwear.

In another aspect, the patch may be one or more adhesive shaped cut-outs. The one or more shaped cut out may be shaped to fit portions of the bottom side of the footwear.

In another aspect, the patch may be one or more patch dots. The one or more adhesive dots may be circular, triangular, heart, flower, or polygonal in shape.

In another aspect, an alarm mechanism may be embedded inside the sole of the footwear. Pressure may cause the alarm mechanism to trigger and produce an audible sound.

In another aspect, the alarm mechanism transmits an alert message to nearby recipients' computer devices either by a short-distance signal communication or via a long-distance signal communication.

These and other objects, features, and advantages of the present disclosure will become more readily apparent from the attached drawings and the detailed description of the disclosure, which follow.

### BRIEF DESCRIPTION OF THE DRAWINGS

The disclosed exemplary embodiments of the invention will hereinafter be described in conjunction with the appended drawings provided to illustrate and not to limit the invention, where like designations denote like elements, and in which:

FIG. 1 presents an isometric view of an exemplary aspect of a movement tracking device producing an audible sound with a first illustrative embodiment of the present disclosure;

FIG. 2 presents an top-down view of an exemplary aspect of the movement tracking device producing an audible sound illustrated in FIG. 1;

FIG. 3 presents an exploded isometric view of an exemplary aspect of the movement tracking device producing an audible sound illustrated in FIG. 1;

FIG. 4 presents an exploded isometric view of an exemplary alternative aspect of the patch illustrated in FIG. 3;

FIG. 5 presents an isometric view of an exemplary aspect the movement tracking device producing an audible sound in use;

Like reference numerals refer to like parts throughout the several views of the drawings.

### DETAILED DESCRIPTION OF THE DISCLOSURE

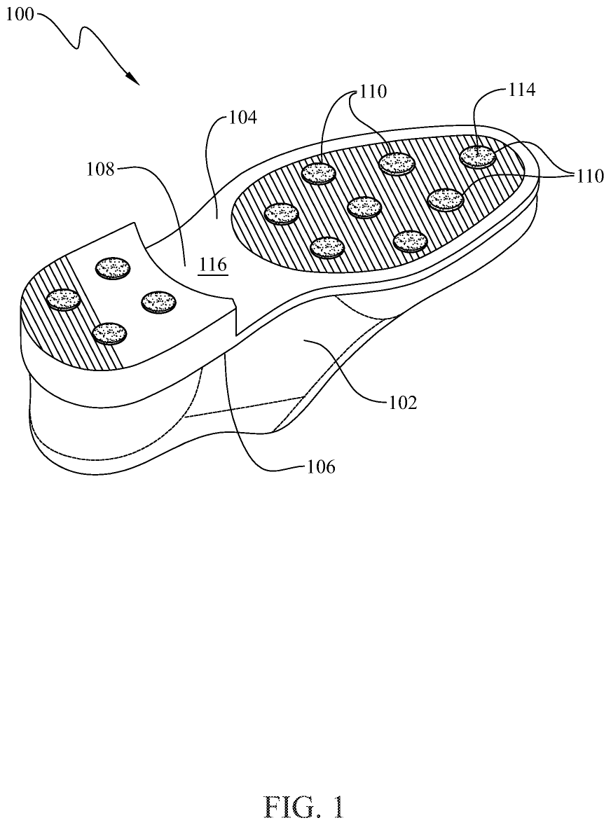

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the exemplary embodiment of the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

As described herein, a movement tracking device which can be attached to footwear to produce an audible sound is provided. In some implementations, a patch comprising adhesive may be applied to a bottom side of footwear to produce an audible sound when the footwear loses contact with a surface. In some implementations, the patch may cover the entirety of the bottom side of the footwear. In alternative implementations, the patch may be one or more shaped cut-outs. In this implementation, the one or more shaped cut out may be shaped to fit portions of the bottom side of the footwear. In alternative implementations, the patch may be one or more dots. In this implementation, the one or more dots may be circular, triangular, flower, heart, or polygonal in shape (e.g., hexagonal, octagonal, etc.). In some implementations, an alarm mechanism may be embedded inside the sole of the footwear. In this implementation, pressure may cause the alarm mechanism to trigger and produce an audible sound. In some implementations, the alarm mechanism transmits an alert message to nearby recipients' computer devices (e.g., computer, smartphone, moble and/or the like) either by a short-distance signal communication (e.g., a short-range radio frequency such as Bluetooth) or via a long-distance signal communication (e.g., ethernet, cellular signal, and/or the like). In this way, the movement tracking device can produce an audible sound when a wearer of the movement tracking device steps, thereby alerting caretakers that the wearer is walking and/or aid in locating the wearer.

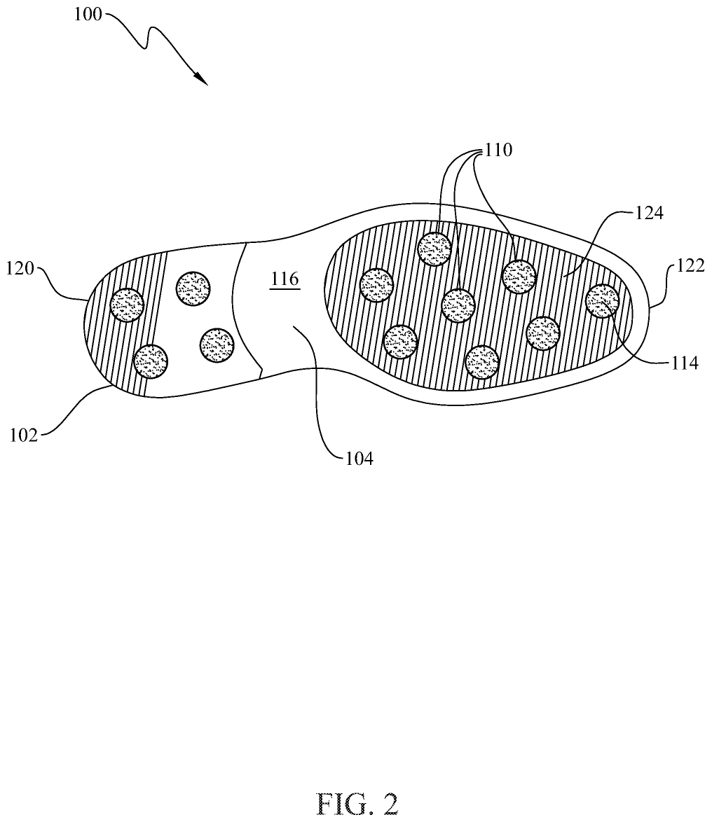

FIGS. 1-5 depict example implementation 100 of a movement tracking device producing an audible sound. FIGS. 1-2 depict an isometric and top-down view of example implementation 100. Example implementation 100 may include footwear 102 and patch 110. The footwear may comprise a footwear bottom side 102, and the patch 110 may comprise an adhesive first side 112 and an adhesive second side 114.

The footwear 102 may be any sort of footwear that can be worn by an individual (e.g., shoes, sandals, slippers, boots, etc.). The footwear may comprise a sole 104. The sole may have a top side 106 and a bottom side opposite the top side 108. The sole's bottom side may be the footwear bottom side 116.

The adhesive first side 112 and adhesive second side 114 may be any sort of adhesive substance such as glues, tapes, polymers, resins, epoxies, or the like and/or any combination thereof. The adhesive first side 112 may be a permanent adhesive or may be a removable adhesive. The adhesive first side 112 may be affixed to the footwear bottom side 116. In some implementations, the patch 110 may cover the entirety of the footwear bottom side 116. In alternative implementations, the patch 110 may be one or more shaped cut-outs, such as a triangular, circular, heart, flower, or polygonal shape. In this implementation, the one or more patch 110 may be shaped to fit portions of the footwear bottom side 116, such as a heel 120, a toe 122, or ball of footwear 124. In alternative implementations, the patch 110 may be one or more dots. In this implementation, the one or more patch 110 dots may be circular, triangular, square, rectangle, flower, heart, or polygonal in shape (e.g., hexagonal, octagonal, etc.).

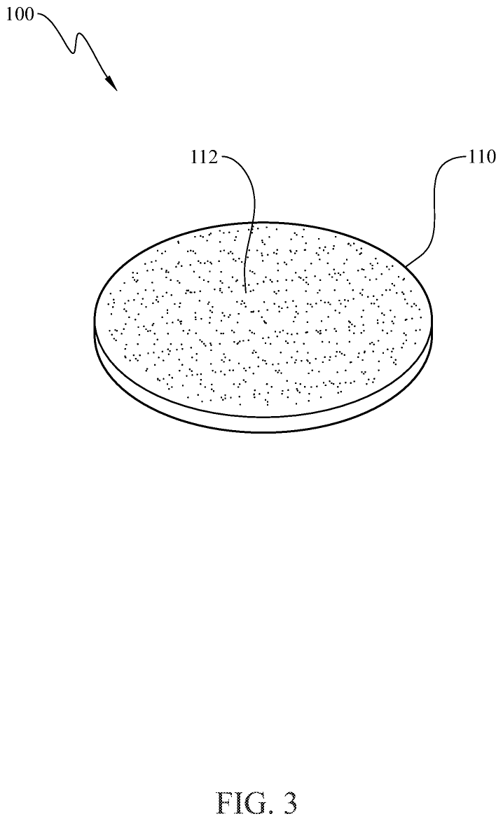

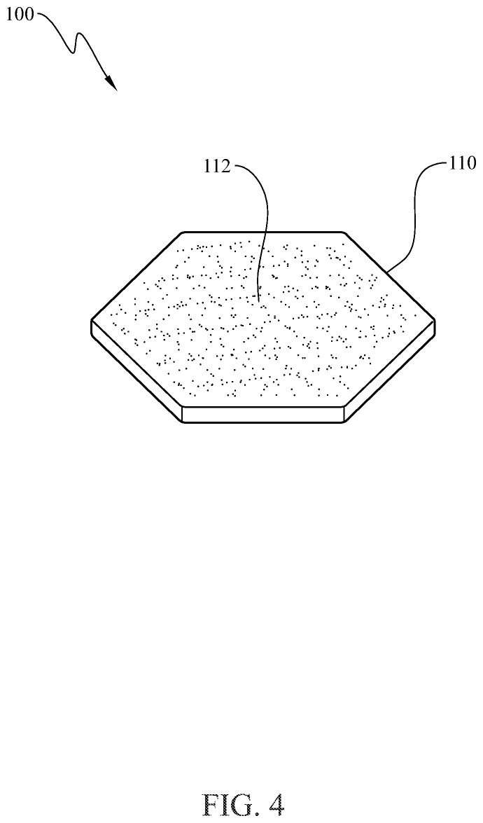

FIGS. 3-4 depict an illustrative example of the patch 110 as dots. In FIG. 3, the patch 110 dots are circular in shape. In FIG. 4, the patch 110 dots are octagonal in shape. As shown in FIGS. 1-2 and 5, each patch 110 dot's adhesive first side 112 may be placed across the footwear bottom side 116 some distance away from other adhesive dots, in a pattern, or randomly placed on the footwear bottom side 116. The patch 110 or plurality of patches 110 may be placed on the footwear bottom side 116 where the footwear bottom side 110 makes contact with a floor or surface 126.

In some implementations, an alarm mechanism, not shown, may be placed or embedded inside the footwear. In this implementation, pressure may cause the alarm mechanism to trigger and produce an audible sound. In some additional and/or alternative implementations, the alarm mechanism transmits an alert message to a computer or mobile device (e.g., computer, smartphone, and/or the like) either by a short-distance signal communication (e.g., a short-range radio frequency such as Bluetooth) or via a long-distance signal communication (e.g., ethernet, cellular signal, and/or the like).

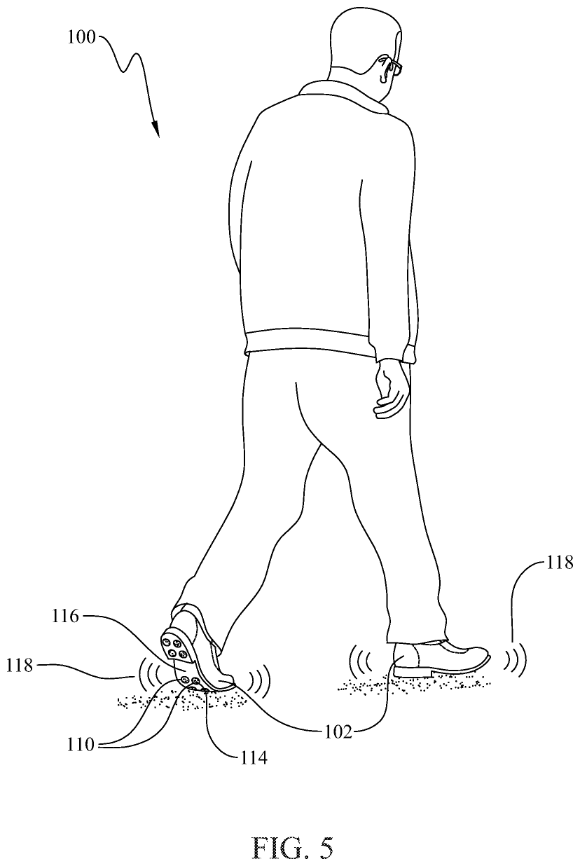

FIG. 5 depicts an illustrative example of example implementation 100 in use as the movement tracking device producing an audible sound is worn by an individual. In FIG. 5, the footwear 110 are shoes and the patch 110 is a plurality of dots. The adhesive first side 112 of the adhesive dots are placed affixed to the footwear bottom side 104 and the adhesive second side 114 make contact with the ground. The adhesive second side 114 can be a removable adhesive that is sticky enough to produce a sound when it releases the floor or surface that it has contacted after a step has been taken by the wearer. When the wearer of the movement tracking device producing an audible sound 100 takes a step with their first foot, the adhesive second side 114 contacts the ground, floor, or surface. The wearer lifts their first foot after taking the step and the adhesive second side 114 releases contact with the ground, floor, or surface and produces an audible sound. When the wearer takes another step with their other foot, the adhesive second side 114 of the patch 110 or of plurality of patches 110 contacts the ground, floor or surface. When the wearer of the movement tracking device producing an audible sound 100 lifts their other foot, the adhesive second side 114 releases contact with the ground floor, or surface and produces an audible sound. When the wearer of the movement tracking device producing an audible sound 100 moves their first foot to take another step, the adhesive second side 114 of the patch 110 or of plurality of patches 110 contacts the ground, floor or surface. When the wearer of the movement tracking device producing an audible sound 100 lifts their first foot again, the adhesive second side 114 releases contact with the ground floor, or surface and produces an audible sound. The adhesive second side 114 of the patch 110 or plurality of patches 110 produces an audible sound each time the adhesive second side 114 releases contact with the ground, floor, or surface.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions.

The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices.

The communication subsystem may comprise wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described exemplary embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A movement tracking device producing an audible sound comprising:
a patch comprising an adhesive;
the adhesive comprising a first side and a second side,
wherein the first side of the adhesive is applied to a bottom side of the footwear,
wherein a second side of the adhesive is opposite the first side of the adhesive,
wherein the second side of the adhesive substance contacts a surface upon each step of the footwear, and
wherein the adhesive substance emits an audible sound upon releasing contact with the surface.

2. A movement tracking device producing an audible sound device comprising:
an alarm mechanism,
wherein the alarm mechanism is located inside footwear, and
wherein the alarm mechanism emits an audible sound when a pressure is applied to the alarm mechanism.

3. The movement tracking device producing an audible sound device of claim 2, wherein the alarm mechanism transmits an alert message to a mobile device.

4. The movement tracking device producing an audible sound device of claim 2, wherein the alarm mechanism transmits an alarm message wirelessly to a computer device and the computer device is selected from the group comprising a cellphone, a smart phone, a computer, a laptop, and a tablet.
